(19) United States
(12) Patent Application Publication
(10) Pub. No.: US 2008/0300719 A1
(43) Pub. Date: Dec. 4, 2008

(54) DRUG DISPENSING CONTROL SYSTEM

(76) Inventor: Stephanie Duke, Minneapolis, MN (US)

Correspondence Address: MERCHANT & GOULD PC, P.O. BOX 2903, MINNEAPOLIS, MN, 55402-0903, US

(21) Appl. No.: 11/944,277

(22) Filed: Nov. 21, 2007

Related U.S. Application Data
(60) Provisional application No. 60/866,994, filed on Nov. 22, 2006.

(51) Int. Cl. G06F 17/00; B65D 83/04

(52) U.S. Cl. 700/244; 221/206

(57) ABSTRACT

A drug dispensing control system and a drug dispensing unit are disclosed. The drug dispensing control system includes a prescription filling system and a drug dispensing unit. The drug dispensing unit is configured to interface with the prescription filling system. The drug dispensing unit includes a canister configured to receive a prescribed amount of medication from the prescription filling system. The canister includes a single dose dispensing mechanism. The drug dispensing unit also includes circuitry configured to allow access to a dose of the medication at a predetermined interval. In certain aspects, the drug dispensing unit is approximately handheld-sized.

### CROSS REFERENCE TO RELATED APPLICATIONS

The present application claims priority to U.S. Provisional Patent Application No. 60/866,994, filed Nov. 22, 2006, the disclosure of which is hereby incorporated by reference in its entirety.

### TECHNICAL FIELD

The present disclosure relates to drug dispensing systems. In particular, the present disclosure relates to a drug dispensing control system.

### BACKGROUND

Improper dosage of legitimate prescriptions is currently a serious problem. A person suffering severe pain, for example, may take more of a prescription analgesic than is appropriate or prescribed. The results of such improper usage can be addiction in the case of pain-killing drugs. If the situation is that a patient, for whatever reason, is not capable of taking a prescribed medicine according to the schedule specified by the doctor, the drug may not effectively treat the patient's disease or condition. Some estimate that as many as three million prescriptions are filled improperly each year.

Accordingly, a mechanism to increase the appropriate prescribing of drugs and the use of prescribed drugs according to the doctor's direction is very likely to increase the likelihood for effective treatment of the patient's condition, and avoid harm such as addiction or excess dosage.

Recently, Federal legislation has created the National All-Substance Prescription Electronic Reporting Act (NASPER) that requires creation of a system for monitoring the dispensing of controlled drugs, typically narcotics, to patients. NASPER requires tracking each patient's usage to substantially reduce the possibility of patients gaming the system in one way or another by, for example, getting multiple prescriptions from different physicians.

For the above and other reasons, improvements are desired.

### SUMMARY

The above and other problems are solved by the following:

In a first aspect, a drug dispensing control system is disclosed. The drug dispensing control system includes a prescription filling system and a drug dispensing unit. The drug dispensing unit is configured to interface with the prescription filling system. The drug dispensing unit includes a canister configured to receive a prescribed amount of medication from the prescription filling system. The canister includes a single dose dispensing mechanism. The drug dispensing unit also includes circuitry configured to allow access to a dose of the medication at a predetermined interval. According to this aspect, the drug dispensing unit is approximately handheld-sized.

In a second aspect, a drug dispensing unit is disclosed. The drug dispensing unit includes a canister configured to receive a prescribed amount of medication. The canister includes a single dose dispensing mechanism. The drug dispensing unit also includes circuitry configured to allow access to a dose of the medication at a predetermined interval. According to this aspect, the drug dispensing unit is approximately handheld-sized. By handheld sized, it is intended that the overall housing size of the drug dispensing unit is sized to fit in a person's hand, such as by resting in the palm of a person's hand.

In a third aspect, a method of controlling prescription drug usage is disclosed. The method includes registering a handheld-sized drug dispensing unit in a prescription drug information network. The drug dispensing unit includes a canister configured to receive a prescribed amount of medication, the canister including a single dose dispensing mechanism. The drug dispensing unit also includes circuitry configured to allow access to a dose of the medication at a predetermined interval. The method also includes communicatively connecting the drug dispensing unit to a prescription filling system. The method further includes filling the drug dispensing unit with a prescribed amount of a drug. The method also includes programming the predetermined interval into the drug dispensing unit.

### BRIEF DESCRIPTION OF THE DRAWINGS

FIG. 1 is a schematic diagram of a drug dispensing network in which aspects of the present disclosure can be implemented;

FIG. 2 shows a generalized block diagram for a drug dispensing control system according to a possible embodiment of the present disclosure;

FIG. 3 shows a block diagram for a drug dispensing control system according to a possible embodiment of the present disclosure;

FIG. 4 shows an example base station usable in the drug dispensing control system of FIG. 3;

FIG. 5 shows a schematic perspective view of an example drug dispensing container usable in the drug dispensing control system of FIG. 3;

FIG. 6 is an exploded view of components of the drug dispensing container of FIG. 5;

FIG. 7 is a side elevation view of the drug dispensing container of FIG. 5;

FIG. 8 is a side elevation view of the drug dispensing container of FIG. 5, at a side adjacent to the side shown in FIG. 7;

FIG. 9 is a top view of the drug dispensing container of FIG. 5;

FIG. 10 is a bottom view of the drug dispensing container of FIG. 5;

FIG. 11 is a perspective view of the drug cartridge useable in the drug dispensing container of FIG. 5;

FIG. 12 is a flowchart of methods and systems for use of the drug dispensing control system of FIG. 3;

FIG. 13 is a flowchart of methods and systems for operation of the drug dispensing container of FIG. 3; and

FIG. 14 is a flowchart of methods and systems for use of the drug dispensing container of FIG. 3.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Furthermore, the logical operations of certain aspects of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to a drug dispensing unit and a drug dispensing control system. The drug dispensing unit, and drug dispensing control system in which it can be employed, provide a system within which prescription drugs can be reliably prescribed while both minimizing risks of incorrect prescriptions and unchecked drug sharing or drug abuse and improving prescription compliance by patients. The systems and methods disclosed herein are configurable to be incorporated into an overall prescription drug regulatory network, such as that implicated in the National All Substance Prescription Electronic Reporting Act (NASPER).

In accordance with the present disclosure, patients in chronic pain who are not able to obtain the necessary medications used to treat their condition because of fear of abuse or doctors' fear of prosecution are able to reliably take prescribed medications. Furthermore, the methods and systems of the present disclosure are adapted to improve compliance with prescriptions in the case of patients utilizing mental health services that need additional monitoring of their medication in order to receive additional benefits from employers, insurance companies, or Medicaid. Typically, patients with mental illness are up to 90% non-compliant with their medications. Additionally, the systems of the present disclosure provide superior data tracking capabilities with respect to dosage accesses, and therefore can be used to provide data relating to FDA regulations for clinical trials and post-market surveillance. Furthermore, the disclosed systems ensure compliance with general medications as determined by practitioners.

Additionally, if the prescribed medication is a controlled substance (scheduled drugs levels 2-4), then information could be registered on NASPER or some other state prescription monitoring program (PMP).

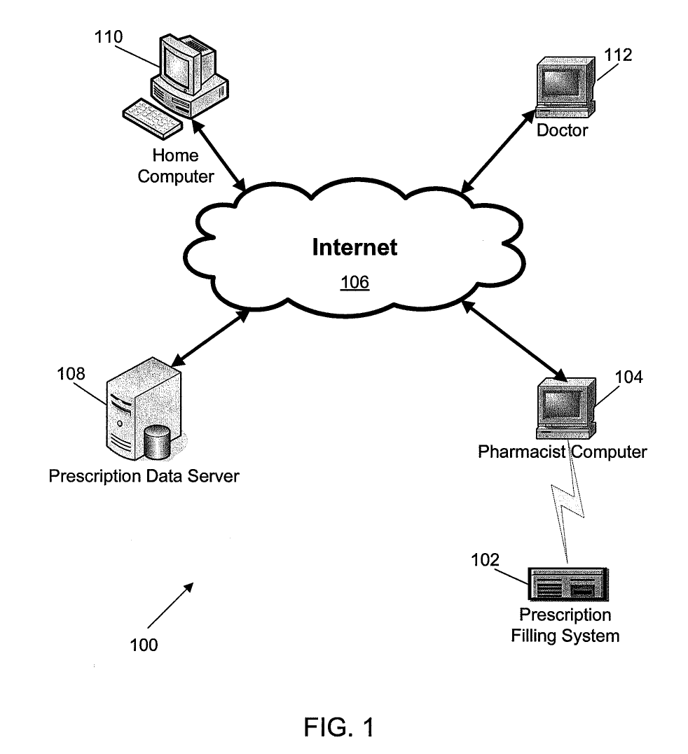

Referring now to FIG. 1, an example prescription network 100 is shown in which the drug dispensing unit and drug dispensing control system can be employed. The prescription network 100 illustrates a system in which medical information, such as information about prescriptions and dosage histories, can be aggregated, stored, and shared with relevant individuals, such as patients, doctors, pharmacists, and other relevant overseeing parties. The prescription network 100 includes a prescription filling system 102 communicatively connected to a workstation 104. The prescription filling system 102 and workstation 104 generally reside at a pharmacy or otherwise under the control of a pharmacist, such that the pharmacist can collect data and track pharmacy customers through use of the workstation 104 and review of patients' prescription histories. In one embodiment, the prescription filling system 102 is electrically connected to the workstation 104 by a communication interface, such as by a local area network, USB connection, or other system connection. In a further embodiment, the prescription filling system 102 and workstation 104 are integrated into a kiosk-type arrangement in which computing functions and prescription filling functions performed by a unitary device.

The workstation 104 is interconnected to a number of devices at other locations by a wide area network, such as the internet 106 shown. The internet 106 refers to any of a number of distributed data sharing networks allowing persons at various locations to access data stored remotely from themselves. In the embodiment shown, the workstation 104 is communicatively interconnected to a prescription data server 108, a home computer 110, and a doctor's workstation 112.

The prescription data server 108 manages a prescription database, which can hold a variety of information about drugs prescribed to a patient. The prescription database can, for example, hold information about prescriptions filled at pharmacies associated with the prescription data server, information about prescriptions written by doctors, rates at which prescriptions are refilled (as compared to rates of scheduled refilling of prescriptions), or other information. The prescription data server 108 can manage this information received from one or more pharmacies, hospitals, doctor's offices, or patient homes. Other information and other sources providing such information can be incorporated into the network 100 as well.

The home computer 110 represents any of a number of generalized personal computing systems capable of connection to the internet or another wide area network. Examples can include a desktop computer, an internet appliance, or a notebook computer wirelessly connected to an 802.11 “hotspot”. Other home computers 110 are possible as well.

The doctor's workstation 112 represents one or more computing systems available to a drug prescribing healthcare professional or institution. The workstation 112 can represent, for example, a hospital or clinic computing network or computing system. Other systems are possible as well.

Furthermore, it is recognized that other computing systems can be integrated into the network 100 as well, as needed. In a possible embodiment, other institutions to whom prescription data is relevant, such as government regulatory institutions, insurance companies, or other institutions, can be granted access to the data stored on the prescription data server 108.

In general, information about prescriptions and drug administration compliance can be shared within the network 100, for example to be stored on the prescription data server 108. Upon request, the prescription data server 108 can access the prescription database stored thereon and provide relevant information to the other computing systems interconnected thereto.

In certain aspects of the present disclosure, software is included which is installable onto the various computing systems included in the network 100, including the prescription data server 108, as well as the various other workstations and computing systems 104, 110, 112 of the network. The software allows for querying and viewing the data held on the prescription data server 108, including information regarding: a patient identifier, drug dispensed, date the drug was dispensed, quantity dispensed, number of refills, prescribing physician, dispensing pharmacist/institution.

In certain embodiments of the present disclosure, the software has the ability to transmit alerts to doctors in real time by sending messages to the prescribing doctor regarding noncompliance with by going on-line or by global positioning systems (GPS) and messaging that doctor to inform them that the dose was taken or that an intervention is necessary. Web-enabled cameras can also be employed to determine if the physical dose was taken.

Furthermore, using the software of the present disclosure, other information can be shared and accessed, via encryption, to doctors, payors, case managers and concerned third parties. In the case of other classes of drugs and for clinical trials the information would go to other data warehouse and available to these persons upon shown necessity.

Using the software described herein, information would only be provided to those authorized to access certain patients' data records on the prescription data server 108. For example, one patient's records can be accessed by that patient, the prescribing physician, the dispensing pharmacist, and other associated regulatory bodies. The patient would not be able to access other patients' records. However, the prescribing physician would have access to records for all patients for whom he/she prescribed medication. Likewise, the dispensing pharmacist or pharmacy would have access to records for all patients for whom that pharmacy prescribed medication (whether or not those records were related to prescriptions filled at that pharmacy), as well as other appropriate regulatory bodies.

Using the software, a doctor could electronically update a prescription, such as by allowing a refill of a prescribed drug. The patient could see that update using their software, and can obtain a refill from a pharmacist. At that point, the pharmacist will update the record, notifying the patient, doctor, and others that the refill prescription has been filled.

Such controlled access and electronic interactions among doctors, patients, and pharmacists maintains privacy to the extent possible, while ensuring that doctors, pharmacists, and regulatory bodies can see records relevant to them to ensure that incompatible drugs are not prescribed, that prescriptions are not filled multiple times without authorization, or other hazardous events. It is preferred that in such software sufficient data privacy measures are incorporated, including encryption, virus protection, and data security, to protect patient medical and pharmacological records.

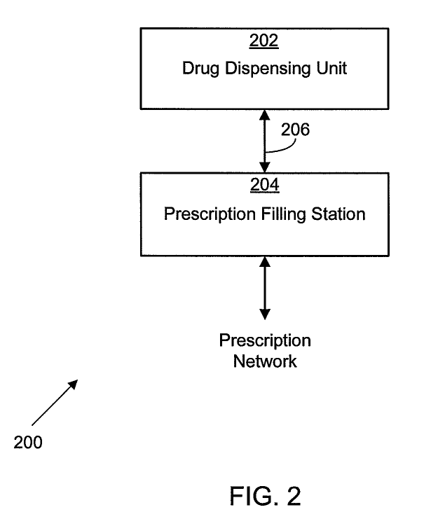

Referring now to FIG. 2, a generalized block diagram for a drug dispensing control system 200 is shown. The system 200 includes a prescription filling system 202 interconnectable with a drug dispensing unit 204. The prescription filling system 202 is generally configurable to program the drug dispensing unit 204 according to the prescription of the drug to be placed into the drug dispensing unit.

The prescription filling system 202 physically and electrically connects to the drug dispensing unit 204. The prescription filling system 202 can take any of a number of forms, but generally is configured to include an unlocking mechanism allowing it to access an interior of the drug dispensing unit 204. The prescription filling system 202 generally receives cartridges containing a prescription drug separable into single doses. The prescription filling system 202 accesses an interior of the drug dispensing unit and inserts the cartridge into the interior. The prescription filling system 202 then secures the interior of the drug dispensing unit, preventing users of the drug dispensing unit (e.g. patients) from accessing more than the specified dosage programmed into the drug dispensing unit according to the prescription. The prescription filling system 202 receives user input to select appropriate drugs to fill a prescription, and also receives dosage instructions, for communication to the drug dispensing unit

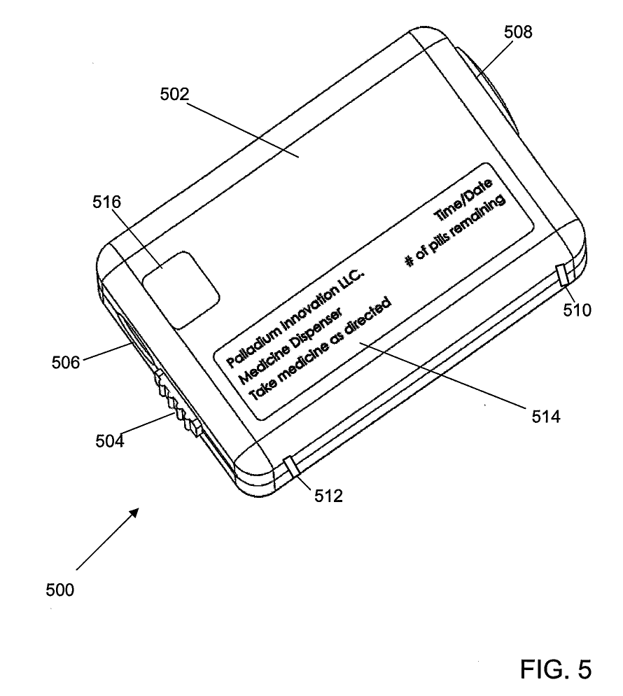

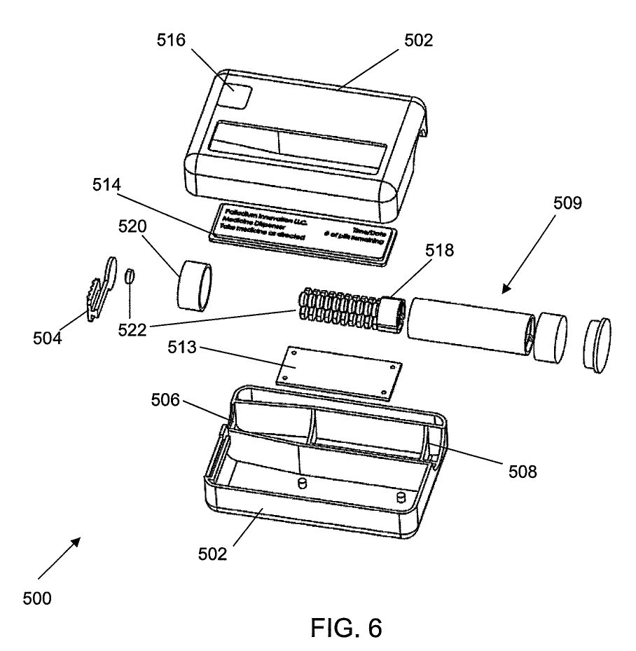

The drug dispensing unit 204 generally is a handheld-sized secure drug dispensing device configured to accept a prescribed amount of a drug into an interior volume of a container, and to secure access to that drug. The drug dispensing unit allows single-dose access to the drug based on rules set when the drug is prescribed to the patient. The drug dispensing unit 204 is described in greater detail below in conjunction with FIGS. 5-7.

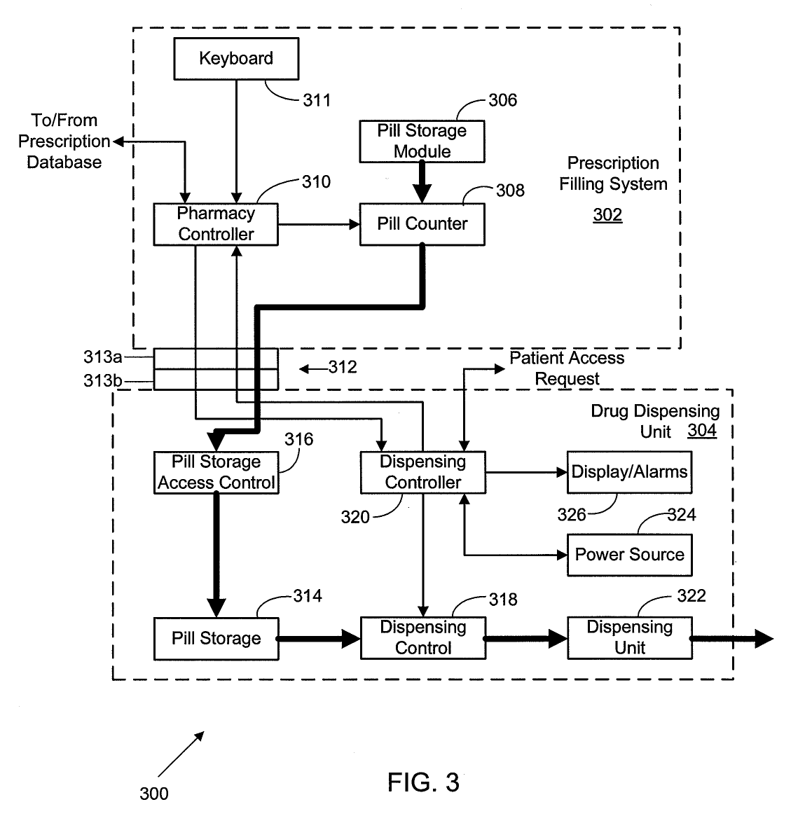

A communicative connection 206 between the prescription filling system 202 and drug dispensing unit 204 allows the prescription filling system to program the drug dispensing unit according to the instructions incorporated into the prescription of the drug held by the drug dispensing unit. The communicative connection 206 is preferably a standardized wired connection allowing the prescription filling system 202 to program the drug dispensing unit 204 with one or more drug dispensing parameters, as described in greater detail below in conjunction with FIG. 3. In various embodiments, the connection 206 is a USB connection providing both information and a power supply to the drug dispensing unit 204.

Optionally, the prescription filling system 202 is connectable as shown to a prescription network which receives and transmits information between the prescription filling system and a computing network. In one embodiment, the prescription filling system 202 includes a network connection connecting the system to a network such as the one described above in conjunction with FIG. 1. Other embodiments are possible as well.

Referring now to FIG. 3, an overall schematic diagram for a drug dispensing control system 300 is shown. The drug dispensing control system 300 includes, as shown a prescription filling system 302 and a drug dispensing unit 304. Although a single prescription filling system and drug dispensing unit are shown, additional systems and units can be incorporated into a drug dispensing control system 300, typically with many drug dispensing units associated with a prescription filling system. In one embodiment, a single prescription filling system is associated with a large number of drug dispensing units, corresponding roughly to the number of patients served by a single pharmacy.

The drug dispensing control system 300 illustrates a process flow for filling and programming the drug dispensing units 304 using the prescription filling system in a manner which regulates and coordinates placement of pills or other drugs into the drug dispensing units as well as access to the pills or other drugs from a unit by the patient associated with that unit. Regarding flow of drugs, a path (shown by the wide lines) begins at a pill storage module 306 in the prescription filling system 302. The pill storage module 306 holds a supply of pills or other drugs in a bulk arrangement, unsorted according to any prescribed dosage related to a patient. A pill counter module 308 receives the drugs from the pill storage module 306, and separates a prescribed amount of the drugs for insertion into the drug dispensing unit 304.

Electrical and/or mechanical control system dependencies and communication are shown in the arrowed lines of the figure. The prescribed amount of drugs to be separated from a bulk drug storage (i.e. the pill storage module 306) is dictated by a pharmacy controller 310, which communicates the pill count to the pill counter module 308. The pharmacy controller receives this number from a pharmacist who is filling the prescription, through use of a keyboard 311 and optional display (not shown), respectively. The pharmacy controller shares input prescription information with a prescription database, such as a database configured for compliance with NASPER regulations. The pharmacy controller 310 can provide information to the prescription database such as: identification information regarding the pharmacy, the patient, and the prescribing doctor; drug identification information; dosage information; historical prescription (refills, etc.) information; date and time information; and other information. The pharmacy controller 310 can also receive information from the prescription database, based on the medical history of the patient with whom the prescription being filled is associated. For example, the pharmacy controller 310 can receive an alert that the drug indicated in the prescription being filled can have adverse side-effects when taken in a certain manner, or in combination with another drug taken by that patient (as tracked by the prescription database). The pharmacy controller 310 can then alert the pharmacist of such potentially adverse conditions, and the pharmacist can in turn communicate his/her concerns with the patient or with the prescribing doctor. Additional alerts or other functionality can be incorporated into the pharmacy controller as well, such as other alerts based on usage of particularly hazardous or addicting drugs, or other situations.

A proprietary connector 312 provides a physical and electrical conduit for communication between the prescription filling system 302 and the drug dispensing unit 304. The proprietary connector 312 includes complementary connections 313a and 313b on the prescription filling system 302 and the drug dispensing unit 304, respectively. The connector 312 as shown is generally a combination of a physical interface and an electrical (communicative) interface. The physical interface aspect allows the drugs to pass from the prescription filling system 302 to the drug dispensing unit 304. The physical interface aspect of the connector 312 unlocks a locking arrangement of the drug dispensing unit 304 to allow access to a storage compartment of the unit to allow the prescription filling system 302 to insert the prescribed drugs into the drug dispensing unit. The physical interface aspect of the connector 312 is also optionally configured to re-lock the drug dispensing unit once the drugs have been transferred to the drug dispensing unit. The electrical or communicative interface aspect provides a method by which the prescription filling system 302 can program or otherwise communicate with the drug dispensing unit. The electrical aspect can constitute a standardized interface, such as a USB or other wired communicative interface, that allows open communication between the systems while at the same time provide an electrical charging station for recharging a power source (e.g. battery) of the drug dispensing unit 304.

When preparing to fill a prescription, a pharmacist mates connector portion 313b of the drug dispensing unit 304 that a patient presents when filling a prescription, with a complementary connector portion 313b of the prescription filling station. The connector portions 313a, 313b mate together to comprise connector 312. Pills can only enter a drug dispensing unit through the connector portion 313b when mated with connector portion 313a.

According to certain regulations, a pharmacist is required to hand-count pills used to fill a prescription. In those systems, a pharmacist may perform the hand counting at an intermediate position between the pill storage module 306 and the connector 312, or may pre-count various types of prescriptions and load prescriptions into various cartridges, which are then pharmacist-selectable in the prescription filling system for sending to the drug dispensing unit 304. In such a system, the pill counter 308 corresponds to a system which selects the appropriate cartridge based on the prescription to be filled for a particular patient.

Once a prescription is filled using the system 300, the prescription filling system 302 sends a signal notifying the prescription database, such as a NASPER registry, that the prescription is filled. If the patient tries to fill a prescription for a similar medication within a prohibited time interval or for a different medication prohibited due to the filling of the first prescription, the prescription database (e.g. as stored on the prescription data server shown in FIG. 1) can notify the pharmacist of the situation, who can then refuse to fill the prescription and take other appropriate action.

The drug dispensing unit 304 generally is a handheld prescription drug container, of approximately the size of existing child-resistant prescription drug containers. The drug dispensing unit 304 generally verifies that the person presenting the unit to a pharmacist is the authorized user of that particular unit. The drug dispensing unit 304 also includes the drugs that are prescribed to the individual, as well as the instructions regarding dispensation of the contained drugs. Furthermore, the drug dispensing unit 304 is generally configured to control the drug dispensation to the patient according to the physician's instructions, as indicated on the prescription.

The drug dispensing unit can take many forms, depending upon the particular drugs to be dispensed or features included. In general, the drug dispensing unit includes a pill storage module 314, a pill storage access control module 316, a dispensing control system 318, a dispensing controller 320, and a dispensing unit 322. Optionally, a power source 324 and various displays/alarms 326 are incorporated into the drug dispensing unit. Other modules and functionality can be incorporated into the drug dispensing unit as well.

The pill storage module 314 stores a filled prescription of drugs in an interior of the drug dispensing unit 304, in a compartment inaccessible to a user. The pill storage module remains secure by at least a mechanical locking mechanism which prevents access to the drugs by methods other than the controlled access methodology provided by the unit 304. A pill storage access module 316 provides a mechanical or electromechanical one-way gate allowing drugs to be placed into the pill storage module 314 by the prescription filling system 302.

A dispensing control system 318 provides a mechanical or electromechanical gate allowing controlled output of drugs to a user upon user request, such as by pressing an access button on the drug dispensing unit (e.g. the access control button shown in FIGS. 5-7). When a user presses an access button, a dispensing controller 320 activates to determine whether the drug dispensing unit should allow dispensation of the drug. If drug dispensation is allowable, the dispensing controller 320 activates the dispensing control system 318, which allows passage of a dose of the prescribed drug, according to the programmed prescription.

The dispensing controller 318 generally includes a microprocessor, an internal day clock, and a memory for storing microprocessor instructions and dispensing history. The memory stores a unique patient ID parameter that is assigned to that patient in the prescription database, and which is used to associate the drug dispensing unit 304 to the patient. The memory also stores dispensing instructions that specify the time interval between successive dispensing events, and is programmable by the prescription filling system 302 according to the prescription to be filled and associated with the unit 304.

A dispensing unit 322 allows passage of a dose of the drugs or other medication stored within the unit 304. The dispensing unit 70 can be no more than a channel within the unit 304 terminating in a conduit through which a pill slides to the outside of the housing (as shown in FIGS. 5-7).

An optional power source 324 is integrated into the drug dispensing unit 304, and can generally provide electrical power for the various components included in the unit. The power source, in various embodiments, is a battery electrically connected to the various electrical components of the unit 304, and is rechargeable at the interface 312 or a secondary interface, such as a USB plug (as seen in FIG. 5).

Additionally, various displays and alarms can be incorporated into the unit 304, illustrated as a display/alarm module 326. The display/alarm module 326 can be any of a number of types of displays or alarms configured to communicate information to a patient or pharmacist, such as an LED display, a LCD display, a sound-emitting chip, or other systems configured to be activated based on various events detected in the unit 304. Events for which the system can display information can include: a last time a dose of medication was accessed; current time; an indication that it is currently time to access medication; an unauthorized access attempt warning or alarm; an overdose alarm; or other events.

Additionally, any number of other electrical or electromechanical systems can be integrated into the system 300 and configured to control operation of the unit 304.

In general, a process for use of the drug dispensing unit 304 is as follows. Each time a patient sends a dispensing request signal, say by pressing an external button on a housing of the unit 304, that applies power to the microprocessor in the dispensing controller 318, which in turn executes a software algorithm. The algorithm checks the current clock time and the dispensing by the arrow. The pill storage access module can be activated, such as by being electrically operated or as a ratcheting type of one-way gate that strongly resists any attempt to gain access to pills or other medication held in storage module 314. Pills are held in storage module 314 until the dispensing controller 320 and dispensing control system 318 allows them to pass to dispensing unit 322.

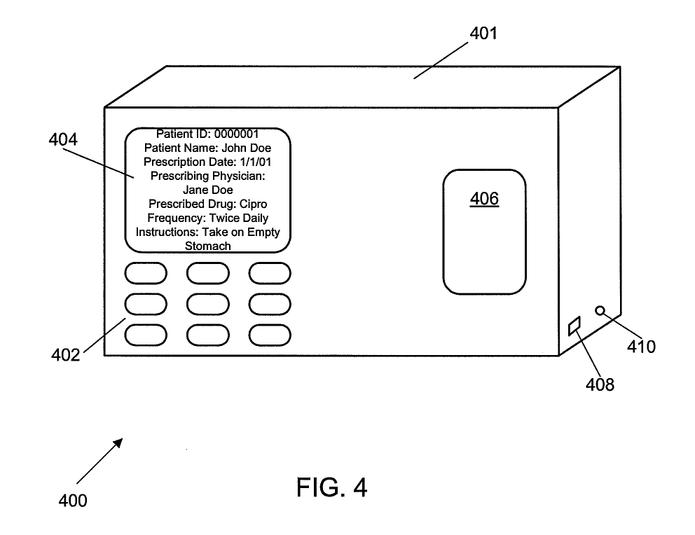

Referring now to FIG. 4, a schematic view of an example base station 400 usable in the drug dispensing control system of FIG. 3 is shown. The base station 400 generally performs the functions of the prescription filling system 302 of FIG. 3, and represents a possible embodiment thereof. Specifically, the base station provides communication with a prescription database, and allows a pharmacist to fill and program drug dispensing units, such as the unit shown in FIGS. 5-7, below.

The base station 400 includes a housing 401 having display 402 and keyboard 404, allowing a pharmacist to view various details of a prescription and enter relevant detains of the prescription handed to him/her by a patient, such as the specific drug, prescribing doctor, the dosage, and other prescription details. The base station 400 reads the identification of a drug dispensing unit, and verifies that the drug dispensing unit corresponds to the patient whose prescription is being filled.

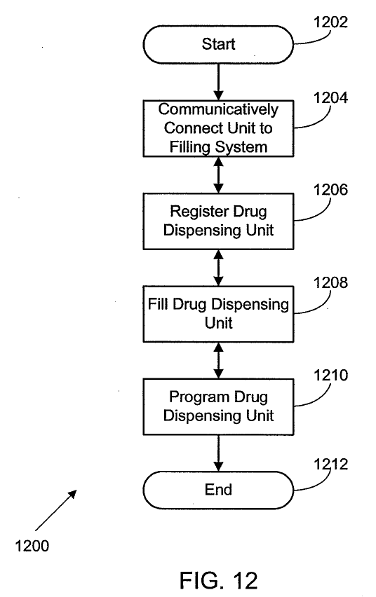

A mounting location 406 in the housing 401 of the base station provides a location at which a drug dispensing unit (not shown) can be placed so as to interface with the base station at a connector location (such as the connector 312 of FIG. 3, above). The mounting location 406 can include, for example, a physical interface allowing the base station to open a drug dispensing unit, insert a prescribed amount of drugs as programmed by a pharmacist, and re-secure the drug dispensing unit. The mounting location 406 also generally would include an electrical interface to program the drug dispensing unit, as previously described, to manage the intervals at which a drug access is allowed. Possible embodiments of drug access procedures which the base station can program into a drug dispensing unit are described below in FIGS. 12-14.

A communication interface 408 can be incorporated into the base station as well. The communication interface 408 can be any of a number of communication interfaces configured to send and receive data in conjunction with another computing system. In one embodiment, the communication interface is a USB or serial interface configured to connect to another local computing system controlled by the pharmacist. In another embodiment, the communication interface 408 is a network plug useable to connect the base station 400 directly to the internet to allow the base station to communicate directly with a prescription data server, such as described above in conjunction with FIG. 1.

A power supply can be connected to the base station 400 as well, such as at a power port 410. Other embodiments providing different power delivery methodologies are possible as well, such as receiving power via USB connection from a local computing system interfaced with the base station 400.

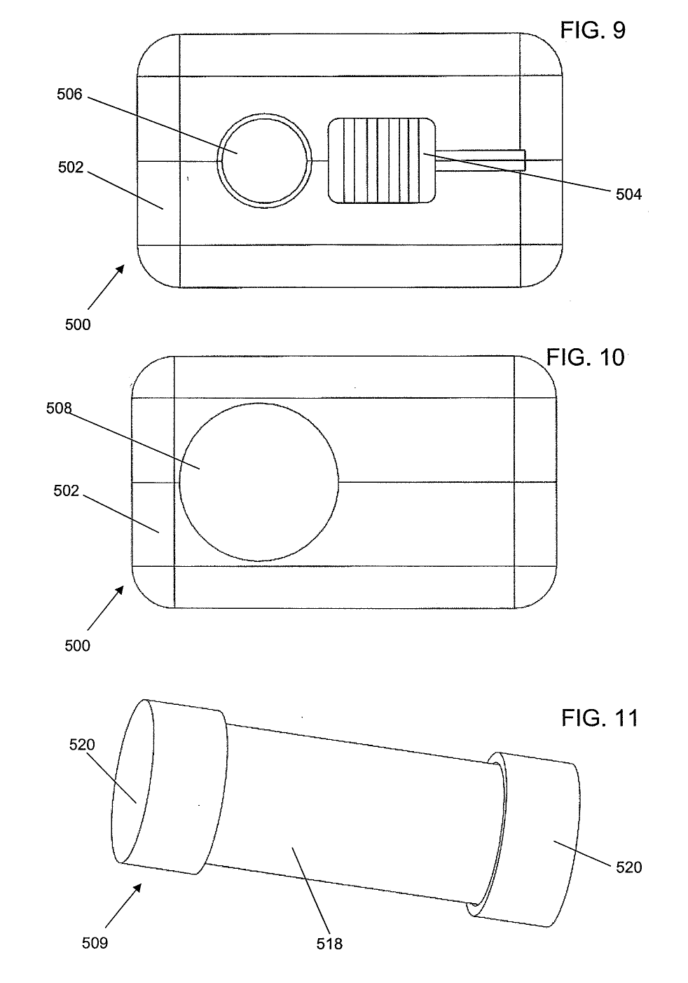

Referring now to FIG. 5-11, schematic views of an example drug dispensing container 500 usable as the drug dispensing unit in the drug dispensing control system of FIG. 3 are shown. The drug dispensing container 500 is generally a handheld, tamper resistant container capable of carrying a filled prescription of medication and providing a user with single doses of that medication at appropriate times throughout the duration of the prescription. The container 500 generally interfaces with a prescription filling system to receive medication in a prescribed amount and to receive instructions regarding a manner in which to allow access to that medication. The container 500 also includes a mechanism for allowing a patient to have access to that medication, on a dose by dose basis.

The container 500 includes a housing 502 having an interior volume capable of holding a number of prescribed doses of a medication. The housing 502 is preferably shaped and arranged to allow easy connection (such as the connector 312 of FIG. 3) to a mounting location of a prescription filling system, such as the location 406 of FIG. 4. In the embodiment shown, the housing 502 has a substantially rectangular cross-section; however other shapes and sizes of the housing are possible as well.

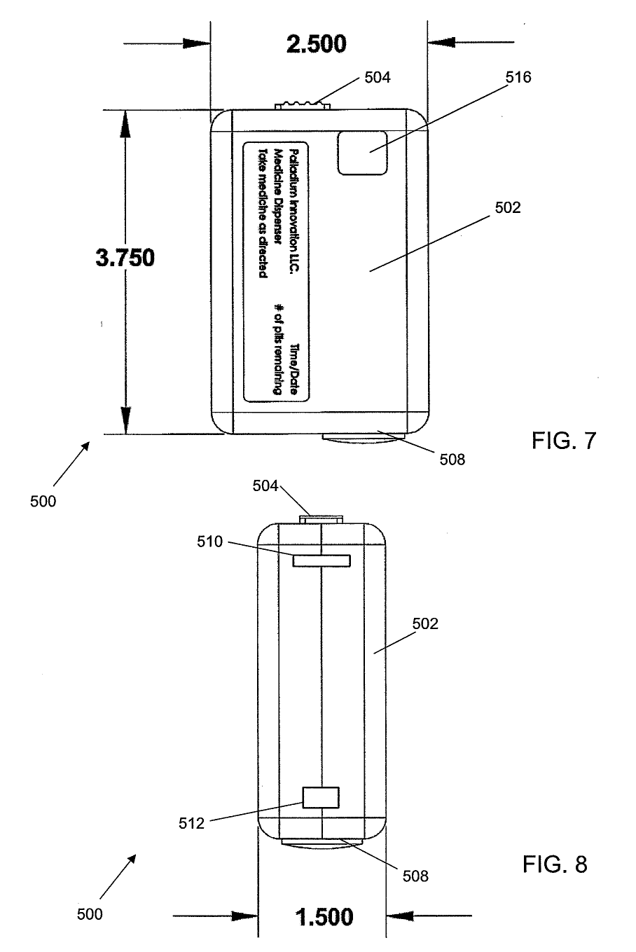

In the embodiment shown, the housing 502 is a two-piece construction formed from a durable plastic or other similar material, and is approximately handheld sized. By handheld sized, it is intended that the housing 502 be able to fit in the palm of one adult's hand, such as by having a perimeter of up to about fifteen inches, with a maximum depth of about 2-4 inches. Typically, the housing 502 can be smaller than these maximum dimensions. Specifically, as noted in FIGS. 7-8, the example housing 502 has dimensions of approximately 2.5 inches by approximately 3.75 inches by approximately 1.5 inches. Other shapes and sizes are possible as well.

The drug dispensing container 500 includes a trigger 504 that provides the mechanism by which a patient indicates to the container that he/she would like access to a dose of medication. The trigger 504 can be a mechanical trigger or electrical button interfaced to a system, such as a microprocessor or other circuitry, which determines whether to provide access to the medication. Example systems for providing access to medication from a drug dispensing unit (such as the container 500) are described below in conjunction with FIGS. 12-14; however, other systems and methods can be implemented in the container 500 for providing access to the medication stored therein. An output opening 506 provides a location through which the dose of medication can pass. In one embodiment, the output opening 506 can be a gated opening that opens after the trigger 504 is pressed and the container 500 determines that access to a dose of medication can be allowed. Alternatively, the output opening 506 can be a chute, and other mechanisms internal to the container can control medication access.

A securable prescription insertion opening 508 is located in the bottom surface of the housing 502, and provides an access opening to the internal volume of the container. The opening 508 can be, in various embodiments, the physical aspect of the connector 312 of FIG. 3, above. The opening 508 includes a hinged cover or other securing mechanism allowing medication to be secured within the housing 502. The opening 508 is accessible preferably only by connection to a prescription filling system, such as the one shown in FIGS. 3-4, above. In one embodiment, a cover of the opening 508 is unlockable and lockable by connection to the prescription filling system 400 of FIG. 4 at the mounting location 406. In a further embodiment, a tamper evident seal is placed over the opening after a prescription is filled, preventing unauthorized (i.e. not through use of the trigger 504 and output opening 506) access to the medication within the container 500 without making such access apparent. If access is apparent, it will be evident to a doctor, pharmacist, or other caregiver that tampering has occurred. Such an indication can, for example, be sent to the doctor or pharmacist when the container 500 is communicatively connected to a network, such as shown in FIG. 1, above Other embodiments are possible as well.

In one embodiment, the securable prescription insertion opening 508 is sized and shaped to receive a prescription capsule 509 into an interior of the container 500. In such an embodiment, the prescription capsule 509 is sized to be received through the opening 508, and contains the prescribed medication to be used with the container 500. In one embodiment, the prescription capsule 509 separates the medication into single doses, such as by separately packaging each single dose. In such an embodiment, each single dose package can be separable from the prescription capsule and can be made accessible to the patient through the output opening upon the container's receipt of an access request via the trigger 504. Additional details regarding the prescription capsule 509 are discussed below.

An electrical interface 510 is located near the prescription insertion opening 508, and provides the electrical aspect of the interconnection between the container 500 and a prescription filling system. The electrical interface 510 can be, in various embodiments, the electrical aspect of the connector 312 of FIG. 3, above.

The electrical interface 510 provides a connection through which a number of interactions between the container 500 and external electronic systems occur. For example, the electrical interface allows the prescription filling system to program the container 500, such as by storing prescription intervals, dosages, patient identification information, and other information into a memory of the container. The electrical interface 510 also allows a prescription filling system to download a medication access history, prescription history, or other patient identification details from the container 500 to allow a pharmacist to determine that a prescription is correctly filled and to allow the pharmacist to warn the patient of potentially dangerous drug interactions not otherwise known. Furthermore, the electrical interface 510 can provide a power source to the container 500, such as to charge a power source such as a battery incorporated into the container. Other electrical and data sharing functions can be provided by the electrical interface consistent with the present disclosure.

In the embodiment shown, the electrical interface 510 is a USB interface capable of connection to either the mounting location 406 of FIG. 4, or to any USB cable for interconnection to a home or office computing system. In such an embodiment, a user can connect the container 500 to a home or office computer having installed on it the data access software described in conjunction with FIG. 1, and can view the relevant records stored in a memory of the container, as well as recharge the battery in the container. In further embodiments, the electrical interface 510 can be any of a number of types of proprietary or standardized electrical interfaces capable of performing one or more analogous functions.

When connected to the home or office computer, a user may choose to upload the prescription history from the container to the prescribing doctor or pharmacist to demonstrate compliance with the prescribed medication. Furthermore, in certain embodiments, additional communication interfaces may be incorporated into the container 500, such as a wireless communication interface capable of synchronizing prescription compliance information with the prescription data server 108, home computer 110, or doctor's computer 112 of FIG. 1. Additional functionality, such as a global positioning system (GPS) or wireless identifier may be incorporated as well.

A power button 512 enables and disables power to portions of the electrical systems integrated into the container 512. For example, portions of the circuitry of the container can not need to operate continuously, such as a display or other user interaction subsystems. Use of the power button 512 allows a patient to conserve the power held in the battery or other power source of the container.

Optionally, the drug dispensing container also includes a number of other features related to managing drug dispensing as well. A display 514 presents a variety of information to a user related to the prescription held within the container 500. For example, the display 514 can show the current date and time, the date and time of the last dosage accessed from the container, the name of the drug held in the container, the name of the patient, the dosage, other information typically printed on an outer surface of a prescription container, or other relevant information. The display can be, in various embodiments, a liquid crystal display (LCD) or other type of low-cost, low power display capable of depicting alphanumeric characters. The display 514 is mountable on a circuit board 513, and is selectively activated to display a variety of information. In the embodiment shown, the display 514 is a three-line display running along a substantial length of the container. Other positions and sizes of the display are possible as well. The display 514 presents a variety of information relating to the container 500, the patient associated with that container, and the associated prescription. Example information presented on the display can include the patient's name, the issuing pharmacy, basic instructions for use, and the number of doses remaining.

An optional indicator 516 indicates any of a number of conditions occurring in the container 500. For example, the indicator 516 can illustrate that the container is activated by the power button 512, or that a sufficient interval has passed such that another dosage of the prescribed medication in the container can be accessed. Additionally, the indicator 516 can be activated upon an unauthorized access attempt of the medication in the container, such as by pressing the trigger 504 before a sufficient interval has passed, or by tampering with another portion of the container. Other possibilities for activating the indicator are possible as well. In the embodiment shown, the indicator 516 is a light emitting diode (LED); however other types of lights or sound indicators can equivalently be incorporated into the container instead of or in addition to an LED.

The prescription container 509 is loadable into the container by a pharmacist, and includes a loading portion 518 and locking caps 520. The locking caps can be removed from the loading portion 518, which can hold and dispense single pills 522 therefrom through the output opening 506. The container 509 can store up to, for example 40-60 pills within a single cartridge, depending upon the size and shape of the pills loaded into the loading portion 518, as well as the arrangement of the pills within the cartridge. The locking caps 520 cover the ends of the loading portion and prevent the pills 524 from escaping the container 509.

The container 500 is generally tamper-proof and tamper-evident, to prevent a patient or other individual from bypassing the trigger 504 and single dose allowance systems to access more of the medication than is prescribed. Such a container is useful, for example, in dispensing highly-addictive medication in a controlled manner or otherwise enforcing compliance with a prescribed medication regimen.

FIG. 12 is a flowchart of methods and systems for use of the overall drug dispensing control system of FIG. 3, according to a possible embodiment of the present disclosure. The system 1200 generally corresponds to initialization and operation of a drug dispensing control system, such as when a patient fills a prescription at a pharmacy. The system 1200 is instantiated at a start operation 1202, which corresponds to an instance in which a patient arrives at a pharmacy to either fill a prescription for a first time or to refill a prescription. Operational flow proceeds to a connection module 1204, which initiates upon a pharmacist communicatively connecting a drug dispensing unit, such as the unit shown in FIGS. 5-11, to a prescription filling system, such as the base station 400 of FIG. 4. The connection module 1204 generally corresponds to establishing a physical and communicative connection between the prescription filling system and the drug dispensing unit, such as the physical and electrical connections described in conjunction with the connection 312 of FIG. 3. Consistent with the present system 1200, the drug dispensing unit connected to the prescription filling system can be a new (previously unregistered) unit, or can be a unit previously associated with the patient.

Operational flow proceeds to a registration module 1206. The registration module 1206 performs any of a number of registration tasks relating to the patient, depending upon whether the patient has used the drug dispensing unit before. If the patient has not used the drug dispensing unit, the registration module 1206 determines whether the patient has an existing patient identifier used in connection with other drug dispensing units. If so, the registration module causes the same patient identifier to be stored in a memory of the drug dispensing unit interfaced to the prescription filling system. If the patient does not have a preexisting patient identifier assigned to him/her, the prescription filling system obtains a new unique patient identifier for storage in the drug dispensing unit, such as from a prescription database connected to the prescription filling system over a network.

If the patient has used the drug dispensing unit before, a preexisting patient identifier is stored in the drug dispensing unit, which allows the pharmacist to verify that the person for whom the prescription is filled actually be the person to whom the prescription is written.

Operational flow proceeds to a fill module 1208. The fill module uses the physical aspect of the connection between the drug dispensing unit and the prescription filling system to insert a desired amount of a prescribed drug into the drug dispensing unit from the prescription filling system. In a possible embodiment, the fill module activates a pill counter, such as the one shown in FIG. 3, to assist in moving pills or other medication from a pill storage module in the prescription filling system to a pill storage module in the drug dispensing unit. In a further embodiment, a prepackaged medication cartridge containing a prescribed amount of a medication can be easily inserted into the drug dispensing unit. The cartridge can be configured having a number of dosages separable within the drug dispensing unit for single-use dispensing.

Operational flow proceeds to a program module 1210, which corresponds to use of the electrical aspect of the connection between the drug dispensing unit and the prescription filling system to store information in a memory associated with the drug dispensing unit. The memory can be, for example, a memory associated with a dispensing controller integrated into the drug dispensing unit. Instructions programmed into the memory can include information about the prescribed medication, such as periods at which it is advised that the medication be accessed, warnings about taking the prescribed medication, warnings or alarms based on taking or not taking the prescribed medication, or other actions.

The program module 1210 can also optionally read existing information in the memory, such as a prescription filling and medication compliance history information stored in the memory based on previous prescriptions, previous medication access times (e.g. a dosage access history), or other data collectable by the drug dispensing unit. In a possible embodiment, the program module 1210 can concurrently charge a power source, such as a battery, incorporated into the drug dispensing unit by using the electrical aspect of the connection between the unit and the prescription filling system.

Operational flow among the modules 1204-1210 can vary according to the specific implementation of the prescription filling system, and are largely a matter of design choice. Furthermore, specific steps performed in any one of the modules (e.g. charging the drug dispensing unit) can be optional, and depend upon the specific features incorporated into the embodiment of the prescription filling system and drug dispensing unit as implemented.

Furthermore, additional modules can be incorporated into the system 1200, such as a module configured to re-lock the drug dispensing unit once the modules 1204-1210 are completed, so as to prevent a patient from bypassing the single-dose access mechanisms of the drug dispensing unit.

Operational flow terminates at an end operation 1212, which corresponds to detachment of the drug dispensing unit and completion of filling of the prescription. Following operation of the system 1200, a drug dispensing unit is associated with a patient, who can use it according to its programming to access medication periodically, on a dose by dose basis.

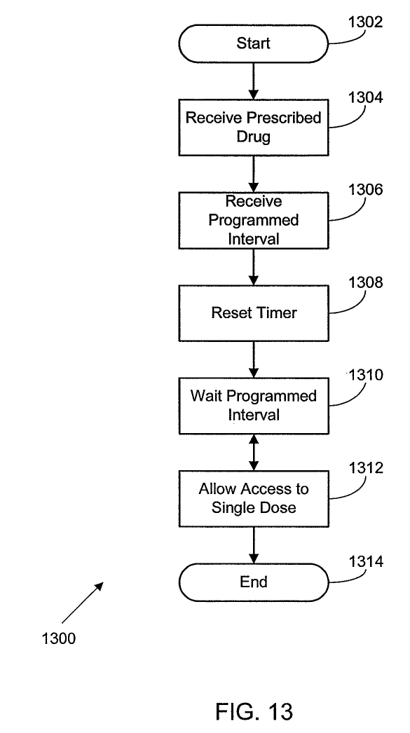

FIG. 13 is a flowchart of methods and systems for operation of the drug dispensing unit of FIG. 3, according to a possible embodiment of the present disclosure. The system 1300 shown corresponds generally to internal operational behavior of a drug dispensing unit, based on the programmed instructions received from a prescription filling system. The system 1300 is instantiated at a start operation 1302, which corresponds to initial use of a drug dispensing unit for prescription medication.

Operational flow proceeds from the start operation 1302 to a drug receipt module 1304. The drug receipt module 1304 corresponds to receipt of pills or other medication in the drug dispensing unit, as described in conjunction with the previous figures. Operational flow proceeds to an interval programming module 1306. The interval programming module 1306 receives a programmable interval from a prescription filling system, such as can be programmed by a pharmacist. The interval corresponds to the time in between doses of medication as indicated on a prescription.

Operational flow proceeds to a timer reset module 1308. The timer reset module 1308 restarts the interval relating to the time in between doses of medication as indicated on a prescription. Operational flow proceeds to a delay module 1310. The delay module 1310 uses a clock integrated into the drug dispensing unit and denies access to any doses of the medication held in the drug dispensing unit for at least the interval programmed into the unit by the interval programming module 1306. Once that interval has passed, the delay module ceases operation, and allows operational flow to proceed to a medication access module 1312. The medication access module 1312 enables a patient to access medication stored in the drug dispensing unit, such as by pressing an activation button on the unit. The medication access module 1312 allows access to a single dose of the medication stored within the drug dispensing unit.

Operational flow among the delay module 1310 and the medication access module 1312 optionally alternates, to allow a patient to periodically access a number of doses of medication held within the drug dispensing unit. In general, the delay module 1310 and access module 1312 alternate in operation the number of times corresponding to the number of doses included in the prescription. At that point, the drug dispensing unit is empty, and must be refilled before operation can continue.

Operational flow terminates at an end operation 1314, which corresponds to completing allowance of at least one dose of the prescribed medication to a patient. In certain embodiments, the end operation 1314 corresponds to allowing periodic access to all of the doses of medication held within the drug dispensing unit, on a dose by dose basis.

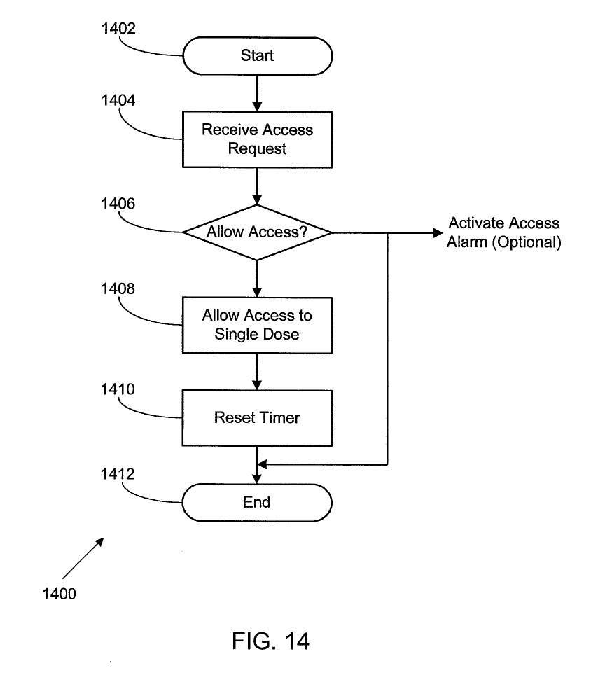

FIG. 14 is a flowchart of additional methods and systems for use of the drug dispensing unit of FIG. 3, according to a possible embodiment of the present disclosure. The system 1400 depicted in this flowchart corresponds to reaction of a drug dispensing unit to a patient, and can be embodied in instructions stored in a memory of the drug dispensing unit for controlling the operation of the unit in response to a request for access to a dose of medication received by the drug dispensing unit.

Operational flow is instantiated at a start operation 1402. The start operation generally corresponds to use by a patient, such as an initial attempt to access medication stored within a drug dispensing unit. Operational flow proceeds to an access request receipt module 1404. The access request receipt module 1404 recognizes that a request for access to a dose of medication has been received by the drug dispensing unit. In one embodiment, the access request receipt module 1404 detects a patient pressing a trigger or other button on the body of the drug dispensing unit. Other triggering actions can be detected as well.

Operational flow proceeds to an access allowance operation 1406. The access allowance operation 1406 determines whether to allow access to a dose of medication from among the doses of medication stored within the drug dispensing module. The access allowance operation 1406 can, for example, determine whether there is any medication contained in the drug dispensing unit, and can also determine whether an interval has passed sufficient to allow access to a dose of medication (e.g. sufficient time has passed between doses, as prescribed). If the access allowance operation 1406 determines that the patient should be allowed access to a dose of medication, operational flow branches ‘yes’ to an allow access module 1408. The allow access module 1408 unlocks a mechanism which allows a single dose of medication to be accessible external to the drug dispensing unit. The mechanism can be, for example Operational flow proceeds from the allow access module 1408 to a reset module 1410. The reset module 1410 resets the timer, thereby requiring the system 1400 to wait another interval of the same length before a subsequent dose of medication will be permitted to be accessed. Operational flow terminates at an end module 1412, which corresponds to completion of an access request response procedure.

If the access allowance operation 1406 determines that the patient should be allowed access to a dose of medication, operational flow branches ‘no’ to the end module 1412, signifying that no access is allowed at that time because at least one conduction (e.g. sufficient time elapsing between doses) has not been satisfied for the allow access operation 1406 to allow a dose to be accessed.

Optionally, upon branching ‘no’ an access alarm or other indicator is activated, indicating that an unauthorized access has been attempted. The access alarm can correspond to a lit LED, or can simply correspond to storing a record in memory of an access attempt that is not in accordance with prescription instructions. Such memory records can be reviewed by the patient, pharmacist, or doctor viewing the patient's history (such as can be uploaded to and stored in the prescription data server of FIG. 1). Other alarms or indicator actions can be possible as well.

The above disclosure provides patients with a reliable way to maintain medication compliance, thereby benefiting the patient by ensuring that proper medication is maintained and benefiting the prescribing doctor/hospital by improving outcomes, improving compliance rates that are determined for future funding, etc. Furthermore, the above disclosure improves data sharing among treating doctors, pharmacists, insurance companies, and patients, allowing therapy data to be monitored by all interested parties.

The above specification, examples and data provide a complete description of the manufacture and use of the composition of the invention. Since many embodiments of the invention can be made without departing from the spirit and scope of the invention, the invention resides in the claims hereinafter appended.

1. A drug dispensing control system comprising:
a prescription filling system; and
a drug dispensing unit configured to interface with the prescription filling system, the drug dispensing unit including:
a canister configured to receive a prescribed amount of medication from the prescription filling system, the canister including a single dose dispensing mechanism; and
circuitry configured to allow access to a dose of the medication at a predetermined interval;
wherein the drug dispensing unit is approximately handheld-sized.

2. The drug dispensing control system of claim 1, wherein the circuitry permits use of the single dose dispensing mechanism at the predetermined interval.

3. The drug dispensing control system of claim 1, further comprising a display disposed on the drug dispensing unit.

4. The drug dispensing control system of claim 1, wherein the display is programmed to show the last time at which a dose was accessed from the drug dispensing unit.

5. The drug dispensing control system of claim 1, further comprising a communicative connection incorporated into the drug dispensing unit for interfacing with the prescription filling system.

6. The drug dispensing control system of claim 5, wherein the communicative connection is a USB connection.

7. The drug dispensing control system of claim 1, further comprising a lock incorporated into the drug dispensing unit, the lock configured to be electrically releasable by the circuitry.

8. The drug dispensing control system of claim 1, further comprising a visual indicator integrated into the drug dispensing unit and configured to activate to indicate to a user that the dose of medication can be accessed from the drug dispensing unit.

9. The drug dispensing control system of claim 1, further comprising a memory integrated into the drug dispensing unit and configured to record a history of doses accessed.

10. The drug dispensing control system of claim 1, wherein the prescription filling system is connected to a communications network.

11. The drug dispensing control system of claim 1, wherein the prescription filling system communicates filled prescriptions to a prescription database.

12. A drug dispensing unit comprising:
a canister configured to receive a prescribed amount of medication, the canister including a single dose dispensing mechanism; and
circuitry configured to allow access to a dose of the medication at a predetermined interval;
wherein the drug dispensing unit is approximately handheld-sized.

13. The drug dispensing unit of claim 12, further comprising a communicative connection configured to interface with a prescription filling system.

14. The drug dispensing unit of claim 13, wherein the communicative connection is capable of interfacing with a personal computer.

15. The drug dispensing unit of claim 13, wherein the communicative connection is a USB connection.

16. The drug dispensing unit of claim 12, further comprising a memory configured to record a history of doses accessed.

17. The drug dispensing unit of claim 12, further comprising a visual indicator configured to activate to indicate to a user that the dose of medication can be accessed.

18. The drug dispensing unit of claim 12, further comprising a lock preventing access to an interior of the canister, the lock configured to be electrically releasable by the circuitry.

19. The drug dispensing unit of claim 18, wherein the circuitry permits use of the single dose dispensing mechanism at the predetermined interval.

20. The drug dispensing unit of claim 19, further comprising a power source arranged to provide electrical power to the circuitry.

21. The drug dispensing unit of claim 12, wherein the canister includes a removable drug cartridge.

22. A method of controlling prescription drug usage, the method comprising:
registering a handheld-sized drug dispensing unit in a prescription drug information network, the drug dispensing unit including:
a canister configured to receive a prescribed amount of medication, the canister including a single dose dispensing mechanism; and
circuitry configured to allow access to a dose of the medication at a predetermined interval;
communicatively connecting the drug dispensing unit to a prescription filling system;
filling the drug dispensing unit with a prescribed amount of a drug; and
programming the predetermined interval into the drug dispensing unit.

23. The method of claim 22, further comprising:
obtaining a dosage access history from a memory of the drug dispensing unit; and
storing the dosage access history in a prescription database.

24. The method of claim 22, further comprising charging a power source integrated into the drug dispensing unit.

25. The method of claim 22, wherein filling the drug dispensing unit with a prescribed amount of a drug comprises inserting a drug cartridge into the drug dispensing unit.
